(19) United States
(12) Patent Application Publication
(10) Pub. No.: US 2018/0202498 A1
(43) Pub. Date: Jul. 19, 2018

(54) DEVICE FOR JOINTING ENGINE DAMPER AND TRANSMISSION CLUTCH

(71) Applicants: Hyundai Motor Company, Seoul (KR); Kia Motors Corporation, Seoul (KR)

(72) Inventors: Sung Yeol KIM, Suwon-si (KR); Seok Young SHIN, Gunpo-si (KR)

(73) Assignees: Hyundai Motor Company, Seoul (KR); Kia Motors Corporation, Seoul (KR)

(21) Appl. No.: 15/823,886

(22) Filed: Nov. 28, 2017

(30) Foreign Application Priority Data
Jan. 16, 2017 (KR) 10-2017-0006955
Jul. 17, 2017 (KR) 10-2017-0090451

(51) Int. Cl. F16D 13/70; F16D 11/14

(52) U.S. Cl. CPC F16D 13/70; F16D 2021/0607; F16D 11/14

(57) ABSTRACT

A device for joining an engine damper and a transmission clutch, may include connecting plates disposed at predetermined positions on the engine damper to be able to transmit power and covering protrusions formed on an input portion of the transmission clutch to be able to transmit power to the protrusions.

### CROSS REFERENCE TO RELATED APPLICATION

The present application claims priority to Korean Patent Applications Nos. 10-2017-0090451 filed Jul. 17, 2017, and 10-2017-0006955 filed Jan. 16, 2017, the entire contents of which is incorporated herein for all purposes by this reference.

### BACKGROUND OF THE INVENTION

### Field of the Invention

The present invention relates to a device configured for jointing an engine damper and a transmission clutch and more particularly, to a device configured for jointing an engine damper and a transmission clutch, the device being able to prevent noise due to backlash at the connecting portion for power transmission between the engine damper and the transmission clutch.

### Description of Related Art

A double-clutch transmission (DCT) is a transmission using a double clutch to connect/disconnect power which is transmitted from an engine, and the double clutch receives engine power through an external damper that absorbs explosion vibration of the engine.

That is, engine power is transmitted in order of engine→external damper→connector→double clutch, in which torsional vibration of the engine is reduced through the external damper.

The external damper is mounted on the engine, the double clutch is connected to a transmission, and the external damper and the double clutch are coupled when the engine and the transmission is coupled.

Meanwhile, an external damper and a double clutch have been coupled through a spline connector in the related art. However, when the present spline connector is used, there are gaps (backlash) between tooth surfaces of the splines, so very loud metallic noises are generated by torsional vibration due to combustion vibration of the engine when the engine idles unless there is a specific backlash removal device configured for removing the gaps.

Using a specific backlash removal device to remove noise causes a problem that when the backlash removal setting is set high, it is difficult to couple an engine and a transmission to each other.

Furthermore, backlash removal devices have a structure of which the durability is very difficult to secure, so the devices are easily worn and lose backlash removal ability even at a mileage of about 10,000 km. As a result, the devices cannot prevent noise and generate loud noises due to torsional vibration of an engine.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a device configured for joining an engine damper and a transmission clutch, the device being able to prevent noise due to backlash at a connecting portion for power transmission between an engine damper and a transmission clutch, using a new coupling structure of a connecting plate and a plate spring between the output portion of the engine damper and the input portion of the transmission clutch instead of splines of a connecting portion used for power transmission between an engine damper and a transmission clutch in the related art.

Various aspects of the present invention are directed to providing a device configured for joining an engine damper and a transmission clutch, the device including connecting plates disposed at predetermined positions on the engine damper to be able to transmit power and covering protrusions formed on an input portion of the transmission clutch to be able to transmit power to the protrusions.

A plate spring may be disposed between the protrusion and the connecting plate and may elastically support the connecting plate so that the connecting plate is in close contact with the protrusion to be able to transmit power.

The connecting plate may have: a power transmission portion being in contact with a first side of the protrusion to be able to transmit forward torque applied in a rotational direction of an engine to the first side; and a load-resistant portion formed opposite to the power transmission portion and disposed at a second side of the protrusion.

The load-resistant portion may be disposed with a predetermined gap from the second side of the protrusion and elastically supported by the plate spring so that the power transmission portion is maintained in close contact with the first side of the protrusion.

A stepped portion recessed in a radial direction of the input portion of the transmission clutch may be formed at the protrusion and the plate spring may be disposed in the stepped portion and fixed to the stepped portion by a bolt fastened in the radial direction of the input portion.

The plate spring may be formed in a plate bent at both end portions and may be compressed between the stepped portion and the load-resistant portion.

Various aspects of the present invention are directed to providing a device configured for jointing an engine damper and a transmission clutch, the device including coupling portions of a connecting member mounted on the engine damper and coupled to protrusions of a center plate of the transmission clutch, in which the coupling portions are formed at positions corresponding to the protrusions and fastened to the protrusions to cover the protrusions and transmit power to the protrusions so that the engine damper and the transmission clutch are coupled to each other.

The coupling portion may have: a torque transmission portion supporting a first side of the protrusion and transmitting engine forward-torque applied in a rotational direction of an engine to the first side of the protrusion; and a torque-resistant portion covering a top of the protrusion and fastened to the top portion of the protrusion to resist engine backward-torque.

The torque-resistant portion may have a fastening hole for inserting a fastener through the top portion of the protrusion and the fastening hole may have a predetermined length in the rotational direction of the engine.

The coupling portion may have a backlash removal portion facing the torque transmission portion in contact with a second side of the protrusion and the backlash removal portion may be rounded on a side being in contact with the second side of the protrusion and elastically press the second side of the protrusion.

The torque transmission portion, the torque-resistant portion, and the backlash removal portion of the coupling portion are integrally connected through the bridge.

According to the device configured for joining an engine damper and a transmission clutch of the present invention, the following effects can be obtained.

First, power is transmitted through the directly coupled structure of the connecting plates that are the output portion of an engine damper and the center plate which is the input portion of the transmission clutch, so it is possible to remove a spline connection structure that has been applied to couple engine damper and a transmission clutch in the related art.

Second, it is thus possible to prevent backlash which is generated by a spline connection structure and the connecting portion for power transmission between the engine damper and the transmission clutch, so it is possible to preclude noise due to backlash and reduce complains about noise from customers and costs for dealing with customer complaints.

Third, there is no demand for a specific backlash removal device, so it is possible to reduce the manufacturing cost by decreasing the number of parts and simplifying the assembly process steps.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a coupling structure for power transmission between an external damper and a double clutch in the related art;

FIG. 2 is a view showing the position where a coupling structure of an engine damper and a transmission clutch according to an exemplary embodiment of the present invention is applied;

FIG. 3 and FIG. 4 are views showing a coupling structure of an engine damper and a transmission clutch according to an exemplary embodiment of the present invention;

FIG. 5 is a view when a connecting plate for power transmission of an engine damper is bolted to protrusions of a center plate; and

FIG. 6 and FIG. 7 are views showing a coupling structure of an engine damper and a transmission clutch according to another exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the intended application and use environment.

In the figures, reference numbers refer to the same or equivalent parts of the present invention throughout the several figures of the drawing.

### DETAILED DESCRIPTION

Reference will now be made more specifically to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described for those skilled in the art to easily achieve it.

First, to help understand the present invention, a coupling structure for power transmission between an external damper and a double clutch in the related art is described.

A double-clutch transmission (DCT) is a transmission using a double clutch to connect/disconnect power which is transmitted from an engine, and the double clutch receives engine power through an external damper that absorbs explosion vibration of the engine.

The external damper is mounted on the engine, the double clutch is disposed in a transmission, and the external damper and the double clutch are coupled when the engine and the transmission are coupled.

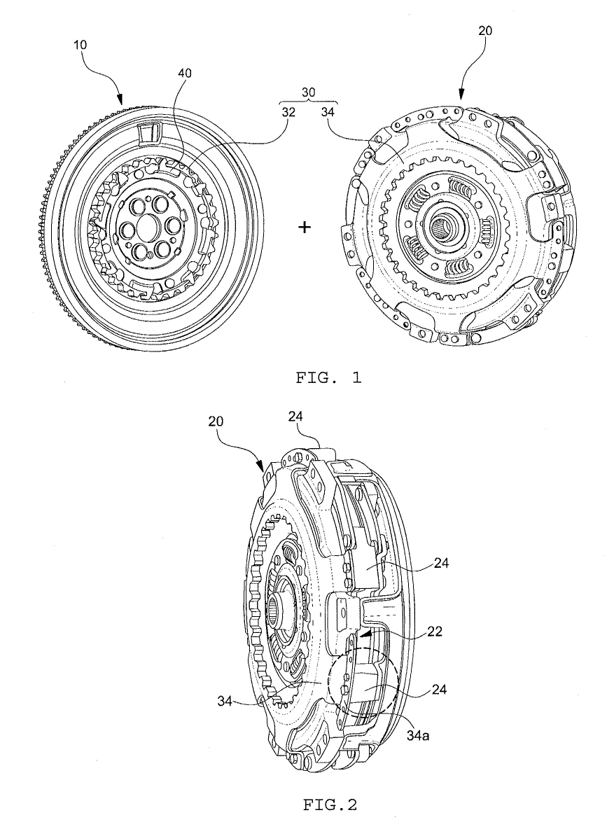

Referring to FIG. 1, an external damper 10 and a double clutch 20 of the related art are coupled through a connector 30 having splines, and for the present coupling, a male connector 32 is mounted on the external damper 10 and a female connector 34 is mounted on the double clutch 20, so the external damper 10 and the double clutch 20 are coupled to be able to transmit power by the coupling of the male connector 32 and the female connector 34.

In the present configuration, engine power is transmitted in order of engine→external damper 10→connector 30→double clutch 20, in which torsional vibration of the engine is reduced through the external damper 10.

When the external damper 10 and the double clutch 20 are coupled through the spline connector 30, a specific backlash removal device 40 is used to remove gaps (backlash) between the splines. This is because very loud metallic noises are generated by torsional vibration generated by an engine (for example, generated by combustion vibration of the engine when the engine idles) if the backlash removal device 40 is not used.

However, when the backlash removal ability of the backlash removal device 40 is set high to remove backlash, it is difficult to couple an engine and a transmission to each other, but if the backlash removal ability is set low, noise due to backlash cannot be prevented due to insufficient backlash removal ability. Furthermore, it is difficult to secure durability of the backlash removal device 40 due to wear of the components, so the device is easily worn and loses backlash removal ability even at a mileage of about 10,000 km. As a result, the device cannot prevent noise or even generates loud noise due to torsional vibration of an engine.

Therefore, according to an exemplary embodiment of the present invention, the external damper mounted on an engine and a double clutch connected to a transmission are coupled to be able to transmit power, and backlash which is generated at the connecting portion between the external damper and the double clutch due to coupling of the external damper and the double clutch is removed so that noise due to the backlash at the connecting portion can be prevented.

In other words, according to an exemplary embodiment of the present invention, noise due to backlash at the connecting portion is basically prevented by applying a new coupling structure, which can transmit power and prevent backlash (gaps), to the connecting portion between a transmission clutch and an engine damper coupled to the transmission clutch to be able to transmit power of dampers mounted on an engine.

First, a position where a new coupling device is applied between an engine damper and a transmission clutch according to an exemplary embodiment of the present invention is described with reference to FIG. 2.

FIG. 2 is a view showing a double clutch of a transmission which is coupled to an external damper of an engine in the related art, in which the double clutch is seen in different direction from the double clutch shown in FIG. 1.

Referring to FIG. 1 and FIG. 2, the male connector 32 which is fastened to the female connector 34 on the external damper 10 is mounted on the double clutch 20 and is bolted to protrusions 24 of the center plate 22 through coupling portions 34a formed on the edge portion thereof.

The center plate 22, which is an input portion of the double clutch 20, receives engine power through the female connector 34 on the external damper 10 and the protrusions 24 are disposed around the edge portion of the center plate 22 to fasten the male connector 32. The protrusions 24 radially protrude on the edge portion of the center plate 22.

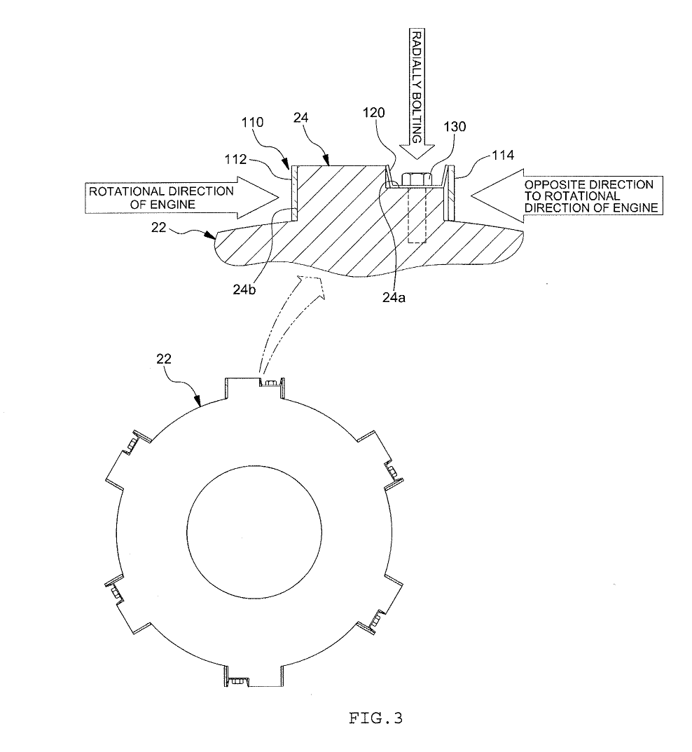

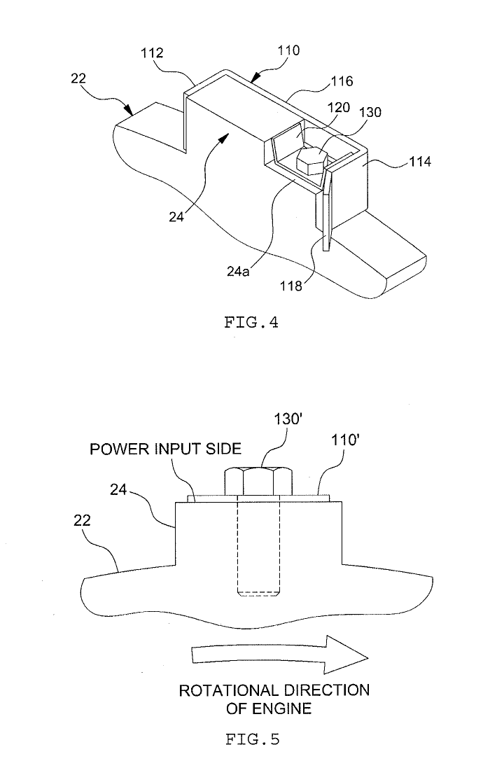

To apply the new coupling device between an engine damper and a transmission clutch in accordance with various aspects of the present invention, the female connector 34 of the external damper 10 which is the engine damper and the male connector 32 of the double clutch 20 which is the transmission clutch are removed, and instead, connecting plates 110 (see FIG. 3 and FIG. 4) for transmitting engine power are disposed at the position of the female connector 34 and are fastened to the protrusions 24 of the center plate 22.

The connecting plates 110, which are output parts of the engine damper, output engine power inputted to the engine damper to the transmission clutch and the center plate 22, which is an input portion of the transmission clutch, receives the power transmitted from the engine damper.

More specifically, the position and number of the connecting plates 110 are set to the protrusions 24 of the center plate 22 and the connecting plates 110 are circumferentially spaced from each other around the engine damper at the position where the female connector 34 of the related art is disposed.

The connecting plates 110 disposed to correspond to the protrusions 24 may be separately circularly disposed or connected to form a single circular connecting member.

The coupling structure between the connecting plates 110 of the engine damper and the center plate 22 of the transmission clutch in accordance with various aspects of the present invention is described in more detail with reference to FIG. 3 and FIG. 4 together with FIG. 1 and FIG. 2.

The connecting plates 110, which are the output parts of the engine damper, are mounted on the engine damper to be able to output power transmitted to the engine damper from an engine and are disposed at the predetermined position of the engine damper (external damper) where the female connector 34 of the related art shown in FIG. 1 is disposed. The connecting plates 110 are spaced circumferentially around the engine damper and the center plate 22 (see FIG. 4).

As shown in FIG. 3 and FIG. 4, the connecting plates 110 are in close contact with the protrusions 24 of the center plate 22 to cover the external sides of the protrusions 24 to be able to transmit power.

More specifically, the connecting plates 110 have a power transmission portion 112 and a load-resistant portion 114 that support both sides of the protrusions 24 disposed in the circumferential direction of the center plate 22 and the rotational direction of the engine.

The power transmission portion 112 presses a side (power input side) of the protrusion 24 when transmitting power to the protrusion 24 and transmits engine forward-torque which is applied in the rotational direction of the engine to the power input side 24b of the protrusion 24.

The power transmission portion 112 transmits engine power in contact with the power input side 24b of the protrusion 24, and to this end, the power transmission portion 112 is formed in a flat plate shape to come in surface-contact with the power input side 24b and transmits the engine forward-torque applied in the rotational direction of the engine shown in FIG. 3 to the power input side 24b.

The power input side 24b of the protrusion 24 is a first side of the protrusion 24 which is positioned at the front in the rotational direction of the engine in both circumferentially disposed sides of the protrusion 24.

The load-resistant portion 114 is formed opposite to the power transmission portion 112, covers the other side, that is, a second side of the protrusion 24. Furthermore, the load-resistant portion 114 is disposed in parallel with the second side of the protrusion 24 and resists engine backward-load.

Furthermore, a plates spring 120 elastically supporting the connecting plate 110 so that the connecting plate 110 is brought in close contact with the protrusion 24 to be able to transmit power is disposed between the protrusion 24 and the connecting plate 110.

The plate spring 120, which is provided to fix the connecting plate 110 and the protrusion 24 to prevent them from separating by elastically supporting the connecting plate 110 covering the protrusion 24, is disposed on the top portion close to the power input side 24b of the protrusion 24 in parallel with the axial line of the center plate 22, and is fastened and fixed by a bolt 130.

A stepped portion 24a recessed in the radial direction of the center plate 22 to mount the plate springs 120 is formed at the rear portion of the top portion of the protrusion 24 in the rotational direction of the engine, and the plate spring 120 is bolted in the stepped portion 24a.

The bolt 130 is fastened to the protrusion 24 through the stepped portion 24a in the radial direction of the center plate 22, so the head of the bolt 130 and the plate spring 120 are accommodated in the stepped portion 24a without protruding further than the front portion (not-recessed portion) of the top portion of the protrusion 24.

Since the plate spring 120 disposed in the protrusion 24 elastically supports the load-resistant portion 114, the load-resistant portion 114 offsets the engine backward-load by the elasticity of the plate spring 120, so even if there is a gap between the protrusion 24 and the load-resistant portion 114, noise due to the gap can be prevented.

In other words, negative (−) load is generated in the opposite direction (backward) to the rotational direction (forward) of an engine, which is backward load (or backward torque) is generated under an operation condition of the engine including acceleration. When the engine backward-load is generated, the load-resistant portion 114 resists the engine backward-load by the elasticity of the plate spring 120, so even though a gap is provided between the protrusion 24 and the load-resistant portion 114, if necessary, the load-resistant portion 114 is prevented from being pushed opposite to the rotational direction of the engine. Accordingly, it is possible to prevent metallic noises due to the load-resistant portion 114 being pushed toward the protrusion 24.

Therefore, the load-resistant portion 114 may be disposed in parallel with the second side of the protrusion 24 with a predetermined gap therebetween, if necessary, and is elastically supported by the plate spring 120 when engine backward-load is generated, whereby the load-resistant portion 114 can be prevented from hitting against the second side of the protrusion 24 and the power transmission portion 112 can be maintained in close contact with the power input side 24b of the protrusion 24.

The plate spring 120 is designed to fix the connecting plate 110 to the protrusion 24 and have elasticity that can resist the engine backward-load; however, if there is no gap between the load-resistant portion 114 and the protrusion 24, it becomes difficult to insert the plate spring 120 between the stepped portion 24a and the load-resistant portion 114, so workability and the assembly convenience are reduced.

Accordingly, it is advantageous in terms of improving the assembly convenience to give a gap between the load-resistant portion 114 and the second side of the protrusion 24.

The second side of the protrusion 24 is the side of the protrusion 24 which is positioned at the rear in the rotational direction of the engine in both circumferentially disposed sides of the protrusion 24.

Referring to FIG. 3 and FIG. 4, the plate spring 120 has a plate shape with two longitudinal end portions bent and is disposed such that the end portions are bent between the load-resistant portion 114 and the stepped portion 24a of the protrusion 24. More specifically, the plate spring 120 is disposed such that the flat center portion is supported by the bolt 130 in close contact with the bottom portion of the stepped portion 24a, a side (first side) of both the bent end portions elastically presses the side of the stepped portion 24a in contact with it and the other side (second side) elastically presses the load-resistant portion 114 in contact with it, elastically supporting the load-resistant portion 114 to which the engine backward-torque is applied.

The connecting plate 110 having the load-resistant portion 114 and the power transmission portion 112 is an ‘U’-shaped plate having a bridge 116 connecting the power transmission portion 112 and the load-resistant portion 114 and is bent such that the power transmission portion 112, the bridge 116, and the load-resistant portion 114 make a right angle with respect to each other to correspond to the shape of the protrusion 24.

The connecting plate 110 is a single portion and is bent such that the power transmission portion 112 and the load-resistant portion 114 at both sides of the bridge 116 surface each other, which is advantageous in terms of securing stiffness and strength.

The bridge 116 is in surface-contact with one of both sides, which are disposed in the axial direction of the center plate 22, of the protrusion 24.

Furthermore, the load-resistant portion 114 has a positioning guide 118 for guiding the connecting plate 110 to a predetermined disposition location in a predetermined posture.

The positioning guide 118 extends from the end portion of the load-resistant portion 114 and guides the disposition location such that the load-resistant portion 114 is positioned close not to the power input side 24b, but to the stepped portion 24a when the connecting plate 110 is coupled to the protrusion 24, whereby a worker can conveniently install the connecting plate 110.

The device configured for jointing an engine damper and a transmission clutch of the present invention having the present configuration transmits power through the directly coupled structure of the connecting plates 110 that are the output parts of an engine damper and the center plate 22 which is the input portion of the transmission clutch, and resists the engine backward-torque which is applied opposite to the rotational direction of the engine due to torsional vibration of the engine while transmitting power, so it is possible to disconnect torsional vibration of the engine and prevent noise due to backlash. Furthermore, since the plate springs 120 are bolted in the radial direction of the center plate 22 by the bolts 130, interference with other surrounding parts is reduced, so workability is improved.

On the other hand, it may be considered to bolt a connecting plate 110′ for power transmission to the top portion of the protrusion 24, but in the instant case, the bolt 130′ receives load through the connecting plate 110′ due to power transmission. Accordingly, considering the maximum torque of an engine, the bolt 130′ requires strong fastening force and the size of the bolt 130′ is correspondingly increased, which is disadvantageous in terms of layout.

However, the bolt 130 in an exemplary embodiment of the present invention has to support the plate spring 120, so a relatively small bolt can be configured. Furthermore, since the stepped portion 24a is formed at the protrusion 24 and the bolt 130 is fastened to the stepped portion 24a, it is advantageous in terms of layout. Since the bolt 130 has a small size, the end portion of the bolt 130 does not interfere with the operation of the transmission clutch even though it is fastened to the stepped portion 24a of the protrusion 24.

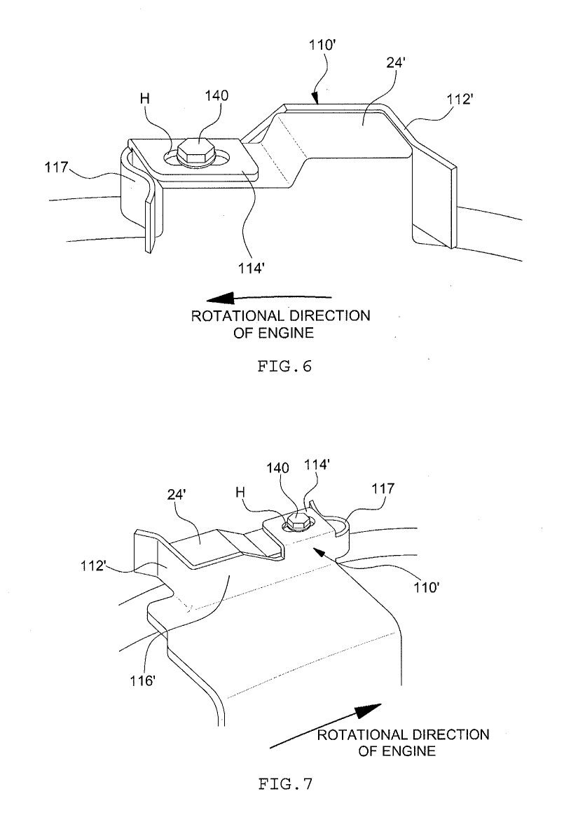

A coupling structure of an external damper (engine damper) and a double clutch (transmission clutch) according to another exemplary embodiment of the present invention is described hereafter with reference to FIG. 6 and FIG. 7, and it should be noted that repetitive description with the coupling structure between an engine damper and a transmission clutch described above will be omitted.

FIG. 6 and FIG. 7 are views showing a coupling structure of an external damper (engine damper) and a double clutch (transmission clutch) according to an exemplary embodiment of the present invention, which show a coupling state of a coupling portion of a connecting member and a protrusion of a center plate.

As shown in the area indicated by a circular dotted line in FIG. 2, the coupling structure of an external damper and a double clutch of the related art includes the female connector 34 which is coupled to the center plate 22 through protrusions 24′ of the center plate of the double clutch 20.

In the exemplary embodiment of the present invention shown in FIG. 6 and FIG. 7, the female connector 34 which is fastened to the center plate 22 of the double clutch through the protrusions 24′ in the related art is changed in shape and fastened, coupling an external damper and a double clutch so that the spline connection structure which is applied between a male connector and a female connector to couple an external damper and a double clutch in the related art can be removed, whereby it is possible to prevent backlash due to the spline connection structures between the external damper and the double clutch in the related art shown in FIG. 1.

A connecting member according to an exemplary embodiment of the present invention is mounted on the external damper as the output portion of the external damper, can be configured as the output portion of the external damper, for example, by changing the shape of the female connector 34 of the related art shown in FIG. 2, and has a plurality of coupling portions 110′ formed at the positions corresponding to the positions of a plurality of protrusions 24′ formed on the external side of the center plate 22.

As shown in FIG. 6 and FIG. 7, the coupling portions 110′ are fastened to the external side of the protrusions 24′ to cover the protrusions 24′, so they each have a torque transmission portion 112′ and a torque-resistant portion 114′ so that the external damper and the double clutch are coupled.

The torque transmission portion 112′ supports a first side of the protrusion 24′ in close contact with the first side and transmits engine forward-torque which is applied in the rotational direction of an engine to the first side of the protrusion 24′.

More specifically, the torque transmission portion 112′ has a flat plate shape to come in surface-contact with the first side of the protrusion 24′, and when an engine is rotated in the arrow direction shown in FIG. 6, the torque transmission portion 112′ transmits engine forward-torque in the rotational direction of the engine to the protrusion 24′.

The torque-resistant portion 114′ covers the top portion of the protrusion 24′, more specifically, it has a flat plate shape to come in surface-contact with the top portion of the protrusion 24′ and is fastened to the top portion of the protrusion 24′ to resist engine backward-torque.

An engine vibrates forwards and backwards in some situations including acceleration of a vehicle or cold explosion and the torque-resistant portion 114′ is formed to resist engine backward-torque when backward vibration is generated. That is, the torque-resistant portion 114′ is maintained in surface-contact with the top portion of the protrusion 114′.

As torque-resistant portion 114′ is fastened to the protrusion 24′ by a fastener 140 tightened through the torque-resistant portion 114′, it has a contact surface that comes in surface-contact with the top portion of the protrusion 24′. A fastening hole H is formed at the center of the torque-resistant portion 114′ so that the fastener 140 to be fastened to the top portion of the protrusion 24′ can pass it, that is, the fastener 140 can be fastened to the top portion of the protrusion 24′.

The fastening hole H may have a predetermined length in the rotational direction of an engine to prepare for cases when the size of the protrusion 24′ is increased or decreased and effectively and securely fasten the torque-resistant portion 114 to the top portion of the protrusion 24′.

The coupling portion 110′ further has a backlash removal portion 117 and the backlash removal portion 117 surfaces the torque transmission portion 112′.

The backlash removal portion 117 forms a U-shape with the torque transmission portion 112′ by facing the torque transmission portion 112′, so it comes in contact with a second side of the protrusion 24′ and elastically pushes the second side of the protrusion 24′ when the coupling portion 110′ is fastened to the protrusion 24′ so that the torque transmission portion 112′ can be come in contact with a first side of the protrusion 24′.

The backlash removal portion 117 may be disposed at a predetermined distance from the torque transmission portion 112′ such that the distance is shorter than the length of the protrusion 24′ in the rotational direction of an engine to prevent backlash between the second side of the protrusion 24′ and the backlash removal portion 117 by come in close contact with the second side.

Furthermore, the backlash removal portion 117 may be rounded such that the side to come in contact with the second side of the protrusion 24′ can come in linear contact with the second side, as shown in FIG. 6 and FIG. 7, and includes an elastic material to press the second side of the protrusion 24′ using the elasticity.

Accordingly, when engine backward-vibration is generated in some situations including acceleration or cold explosion, the backlash removal portion 117 can transmit the engine backward-torque to the second side of the protrusion 24′ by the shape and material characteristics thereof, so it can clearly prevent backlash between the coupling portion 110′ and the protrusion 24′.

The torque transmission portion 112′, the torque-resistant portion 114′, and the backlash removal portion 117 of the coupling portion 110′ may be integrally formed to correspond to the shape of the protrusion 24′. Furthermore, for example, as shown in FIG. 6 and FIG. 7, the coupling portion 110′ may be a substantially ‘U’-shaped plate having a bridge 116′ connecting the torque transmission portion 112′ and the backlash removal portion 117, in which the torque transmission portion 112′ and the torque-resistant portion 114′ are bent from the bridge 116′ to come in contact with the first side and the top portion of the protrusion 24′, respectively.

In other words, the coupling portion 110′ may be formed such that the torque transmission portion 112′, the torque-resistant portion 114′, and the backlash removal portion 117 are integrally connected by the bridge 116′.

This is for effectively secure stiffness and strength of the torque transmission portion 112′, the torque-resistant portion 114′, and the backlash removal portion 117 by integrally bending the coupling portion 110′ with the edge portions rounded without cutting or bonding the edge portions.

As described above, according to an exemplary embodiment of the present invention, the forward-torque transmission side (torque transmission portion) and the backward-torque transmission side (torque-resistant portion) of each of the coupling portions 110′, which are fastened to the protrusions 24′ of the center plate 22 of the double clutch, of a connecting member of an external damper are separated and cover both sides of each of the protrusions 24′ to be able to transmit and resist engine forward-torque and backward-torque. Furthermore, since there are provided the backlash removal portions 117, backlash at the connecting portion of the external damper and the double clutch can be removed to prevent noise due to the backlash.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A device for joining an engine damper and a transmission clutch, the device including connecting plates disposed at predetermined positions on the engine damper to transmit power and covering protrusions formed on an input portion of the transmission clutch transmit power to the protrusions.

2. The device of claim 1, wherein a plate spring is disposed between the protrusions and the connecting plates and elastically supports the connecting plates so that the connecting plates are in contact with the protrusions to transmit the power.

3. The device of claim 2, wherein the connecting plates has: a power transmission portion being in contact with a first side of the protrusions to transmit forward torque applied in a rotational direction of an engine to the first side thereof; and a load-resistant portion formed opposite to the power transmission portion and disposed at a second side of the protrusions.

4. The device of claim 3, wherein the load-resistant portion is disposed with a predetermined gap from the second side of the protrusions and elastically supported by the plate spring so that the power transmission portion is maintained in contact with the first side of the protrusions.

5. The device of claim 3, wherein a stepped portion recessed in a radial direction of the input portion of the transmission clutch is formed at the protrusions and the plate spring is disposed in the stepped portion.

6. The device of claim 5, wherein the plate spring is fixed to the stepped portion by a bolt fastened in the radial direction of the input portion.

7. The device of claim 5, wherein the plate spring is formed in a plate bent at first and second end portions thereof and is compressed between the stepped portion and the load-resistant portion.

8. The device of claim 3, wherein the load-resistant portion has a positioning guide for guiding the connecting plates to a predetermined installation position.

9. The device of claim 3, wherein the connecting plates have a bridge connecting the power transmission portion and the load-resistant portion to each other and the portions between the power transmission portion, the bridge, and the load-resistant portion are bent to correspond to a shape of the protrusions.

10. A device for jointing an engine damper and a transmission clutch, the device including coupling portions of a connecting member mounted on the engine damper and coupled to protrusions of a center plate of the transmission clutch,
wherein the coupling portions are formed at positions corresponding to the protrusions and fastened to the protrusions to cover the protrusions and transmit power to the protrusions so that the engine damper and the transmission clutch are coupled to each other.

11. The device of claim 10, wherein the coupling portion has:
a torque transmission portion supporting a first side of the protrusions and transmitting engine forward-torque applied in a rotational direction of an engine to the first side of the protrusions; and
a torque-resistant portion covering a top of the protrusions and fastened to the top portion of the protrusions to resist engine backward-torque.

12. The device of claim 11, wherein the torque-resistant portion has a fastening hole for inserting a fastener through the top portion of the protrusions and the fastening hole has a predetermined length in the rotational direction of the engine.

13. The device of claim 11, wherein the coupling portion has a backlash removal portion facing the torque transmission portion in contact with a second side of the protrusions.

14. The device of claim 13, wherein the backlash removal portion is rounded on a side being in contact with the second side of the protrusions and elastically presses the second side of the protrusions.

15. The device of claim 13, wherein the torque transmission portion, the torque-resistant portion, and the backlash removal portion of the coupling portion are integrally connected through a bridge.
